(19) United States
(12) Patent Application Publication
(10) Pub. No.: US 2007/0163273 A1
(43) Pub. Date: Jul. 19, 2007

(54) Liquid Purge for a Vaporizer

(75) Inventors: Richard J. Udischas, Joliet, IL (US); Hwa-Chi Wang, West Chester, PA (US)

Correspondence Address: AIR LIQUIDE;Intellectual Property, 2700 POST OAK BOULEVARD, SUITE 1800, HOUSTON, TX, 77056, US

(73) Assignee: American Air Liquide, Inc., Houston, TX (US)

(21) Appl. No.: 11/462,286

(22) Filed: Aug. 3, 2006

Related U.S. Application Data
(60) Provisional application No. 60/759,471, filed on Jan. 17, 2006.

(51) Int. Cl. F17C 9/02

(52) U.S. Cl. 62/50.2

(57) ABSTRACT

Disclosed herein is an apparatus for supplying a liquefied chemical gas comprising a vaporizer disposed within a fabrication plant, the vaporizer adapted to receive the liquefied chemical gas and output a vaporized chemical gas, a purge vessel connected to and in fluid communication with the vaporizer, and wherein the vaporizer is adapted to purge a volume of the liquefied chemical gas and the purge vessel is adapted to receive the volume of liquefied chemical gas. Other embodiments and methods are described herein.

### CROSS-REFERENCE TO RELATED APPLICATIONS

The present application claims the benefit of U.S. Provisional Application Ser. No. 60/759,471, flied Jan. 17, 2006, entitled Liquid Purge For Bulk Liquefied Delivery of Gases, which is hereby incorporated herein by reference.

### STATEMENT REGARDING FEDERALLY SPONSORED RESEARCH OR DEVELOPMENT

Not applicable.

### BACKGROUND

The semiconductor industry is today confronted with increasing needs for electronic specialty gases used in the various steps necessary for the fabrication of semiconductor devices. Electronic specialty gases include, for example, NH₃ (ammonia), HF, HCl, Cl₂, HBr, N₂O, WF₆, and BCl₃, only to name a few. These chemical gases typically liquefy at ambient temperature, and because of this fact pose difficulties in their distribution. These difficulties are directly related to their pressure and flow rate during utilization. Because semiconductor manufacturing facilities may require high flow rates, pressure and temperature must be closely monitored and manipulated in the systems used to store and deliver these gases to the point of use in the manufacturing facility. In addition, purity of the chemical gases is affected by changes in temperature and pressure, and must also be monitored and maintained.

In many semiconductor fabrication applications, high flow rates at the point of use require liquefied delivery of these gases adjacent up to the point of use, where the liquefied gas is then vaporized and used. Delivery from a source, which may be located some distance from the end user, in vapor form limits the flow rate generated and the pressure maintained within the system, causing problems for high flow rate applications. For example, the fabrication of liquid crystal flat panel displays (LCD screens), known also as thin film transistor (TFT) screens, and LED light sources may require especially high flow rates of chemical gases. Flow rates of approximately 500 or 1,000 L/min of ammonia, for example, may be required for these fabrications. Thus, liquid delivery of the chemical specialty gases to a point as close as possible to their point of use is desirable. However, since most applications and processes at the point of use require gas phase product, it is necessary to transform the liquid phase product into gas phase product. This type of transformation, which is well known to persons of ordinary skill in the art, is typically achieved with a vaporization system.

Not all liquid phase product that is delivered to a vaporizer system will be vaporized into gas phase product. Thus, a vaporizer contains volumes of both liquid and vapor phase gases. Also, it is well known that liquid phase chemical gases contain a higher percentage of heavy impurities, such as water, metal and oils, than do their counterpart vapor phases, partially because the liquid phase product has a higher capacity for absorbing the impurities. For these reasons, as the liquid phase gases are vaporized to provide the vapor phase end product, portions of the heavy impurities are transferred to the vapor phase product while certain amounts of the impurities are left behind in the liquid phase product. As more and more liquid phase product is vaporized, the percentage of impurities contained in the liquid phase product stored in the vaporizer increases with time. As the impurities in liquid phase source product further concentrate, more of the impurities appear in the vapor phase end product until the vapor phase product becomes contaminated and exceeds an end user's specification. This concentration effect is exacerbated in vaporizers that store only a small volume (approximately 4 to 6 liters) of liquid phase product from which to produce a vapor.

Therefore it is desirable to purge a contaminated liquid phase source product from a vaporizer before the contaminated product is vaporized and undesirably affects the purity level of the end use vapor phase product. Thereby, a predetermined purity level of the vapor phase product may be maintained. Further, purge of the vaporizer in the fab or otherwise in close proximity to the point of use is desirable for keeping the entire fabrication system running.

### SUMMARY

In an embodiment of the invention, an apparatus for supplying a liquefied chemical gas comprises a vaporizer disposed within a fabrication plant, the vaporizer adapted to receive the liquefied chemical gas and output a vaporized chemical gas, a purge vessel connected to and in fluid communication with the vaporizer, and wherein the vaporizer is adapted to purge a volume of the liquefied chemical gas and the purge vessel is adapted to receive the volume of liquefied chemical gas. In another embodiment, an apparatus for purging a liquefied chemical gas comprises a ton vessel disposed apart from a fabrication plant, the ton vessel including a liquefied chemical gas and a heater, the ton vessel in fluid communication with a vaporizer disposed within the fabrication plant, a purge vessel connected to and in fluid communication with the ton vessel, and wherein the ton vessel is adapted to purge a volume of the liquefied chemical gas and the purge vessel is adapted to receive the volume of liquefied chemical gas. Other embodiments and methods are described herein.

### BRIEF DESCRIPTION OF THE DRAWINGS

For a more detailed description of preferred embodiments of the present invention, reference will now be made to the accompanying drawings, wherein:

FIG. 1 is a schematic illustration of a system for storing, vaporizing and delivering chemical gases to an end user including a purge apparatus in accordance with all embodiment of the invention;

FIG. 2 is a schematic illustration of a portion of a vaporizer and purge apparatus in accordance with an embodiment of the invention;

FIG. 3 is a schematic illustration of a portion of a vaporizer and purge apparatus in accordance with another, embodiment of the invention;

FIG. 4 is a schematic illustration of a portion of the vaporizer and purge apparatus of FIG. 3;

FIG. 5 is a schematic illustration of a portion of a toll vessel and purge apparatus in accordance with another embodiment of the invention; and

FIG. 6 is a flow diagram for a process for purging a contaminated liquid from a vaporizer in accordance with an embodiment of the invention.

### DESCRIPTION OF PREFERRED EMBODIMENTS

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to.” Also, the following discussion makes specific reference to ammonia when describing, the various embodiments, but it should be understood that ammonia may be replaced by various other electronic specialty gases, such as the ones previously mentioned. Various components described herein are connected by or communicate through conduits or lines, and it is to be understood that the terms “conduit” or “line” may include pipes, tubes, or other means for transporting gases and their liquid phase counterparts.

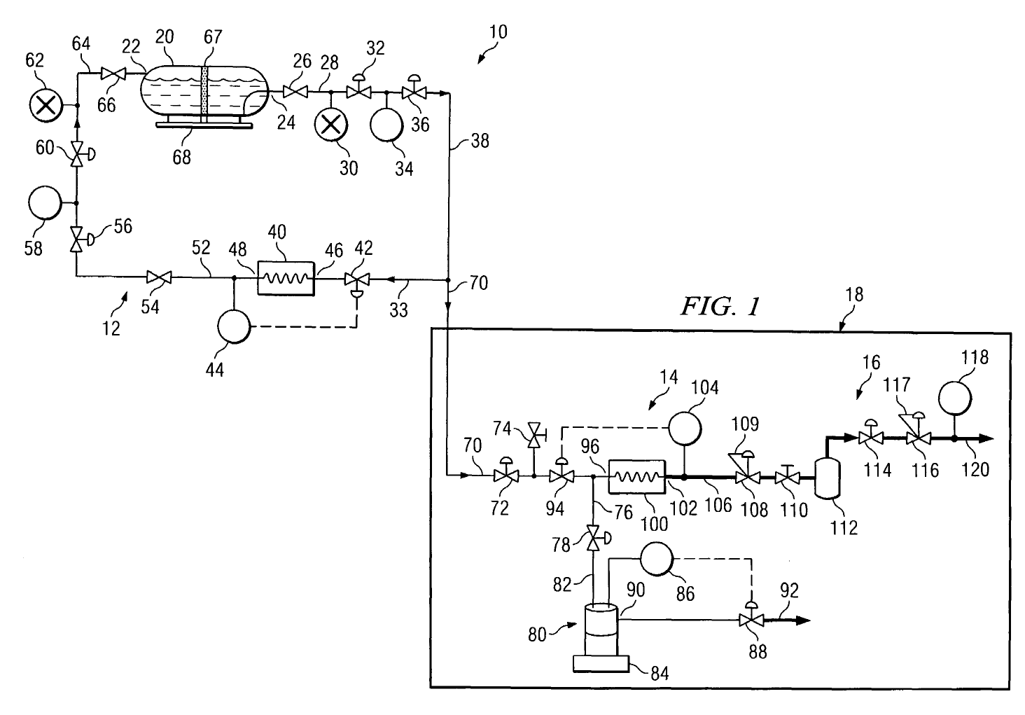

With reference to FIG. 1, a liquefied chemical gas storage, vaporization and delivery system 10 is shown having a storage and pressure build portion or circuit 12, a vapor production portion 14, and a delivery portion 16. As will be noted in more detail below, system 10 and portions thereof, such as storage and pressure build circuit 12 and delivery portion 16, are exemplary only and are described in detail to provide a context for operating an embodiment of the purge apparatus of the present invention. In the exemplary embodiment of FIG. 1, vapor portion 14 and delivery portion 16 may be understood to be part of a fabrication plant 18, and storage circuit 12 may be located some distance from fab 18, such as at an offsite location. However, it should be noted that the embodiments of the present invention described herein may be operated in conjunction with other systems or independently of such systems. The present invention should not be limited to the systems, or portions thereof, described herein and persons of ordinary skill in the art will appreciate that the present invention may be used with liquefied chemical gas storage, vaporization and delivery systems other than those specifically described herein.

A storage and pressure build portion 12 further includes a source container 20. A source container 20 may comprise an iso-container, which may hold approximately 17,000 to 20,000 liters of liquid, or a ton vessel, which may hold approximately 900 liters, for example. Source container 20 also includes a heater 67 and a vaporizer 40. Source container 20 includes an inlet 22 and an outlet 24, and may rest upon a scale 68. A valve 26 is disposed adjacent outlet 24, and may facilitate the disconnection/reconnection of source container 20 from conduit 28 or regulate the flow of fluid into conduit 28. A purge point 30 is located just downstream of valve 26, and may be used to perform a vacuum or pressure purge using N₂ or other appropriate purge gas during disconnection/reconnection of source container 20, as is known by persons of ordinary skill in the art. Conduit 28 leads to an array of valves 32, 36 and pressure transducer 34 for regulating and monitoring the fluid flow in conduit 28. Conduit 28 leads into a conduit 38, which connects to a valve 42 adjacent vaporizer 40 having, inlet 46 and outlet 48. Various vaporizers may be used with the embodiments of the present invention described herein, such as electrical or shell and tube heat exchanger type vaporizers, as well as others known to persons of ordinary skill in the art.

Outlet 48 of vaporizer 40 leads into conduit 52, which includes a pressure switch 44 coupled to valve 42, and a valve 54. Downstream of valve 54 is valve 56, pressure transducer 58, valve 60, purge point 62, conduit 64 and valve 66, which complete the storage and pressure build circuit at inlet 22 of source container 20. Alternatively, in warm or controlled climates, for example, the pressure build feature of circuit 12 (e.g., vaporizer 40) may not be needed for liquid delivery from source container 20. It should be noted that the present invention should not be limited to the storage and pressure build circuit, or any components thereof, described herein and persons of ordinary skill in the art will appreciate that the present invention includes storage and pressure build circuits other than those specifically described herein.

Still referring to FIG. 1, vapor production portion 14 is connected to portion 12 via delivery conduit or line 70. The details of delivery line 70 are known to persons of ordinary skill in the art. For example, line 70 may have a specified inner diameter to maintain liquid phase transportation of the source product, line 70 may be insulated in a variety of ways, and line 70 may have varying lengths such that circuit 12 or source container 20 may be located at remote locations relative to fab 18. Line 70 connects to valve 72, which then directs fluid flow to a purge valve 74 and a solenoid valve 94. Solenoid valve 94 directs fluid flow toward a vaporizer 100 having inlet 96. Communicating with inlet 96 is a purge line 76 having a valve 78 directing fluid flow to purge apparatus or vessel 80. Purge vessel 80 includes an inlet 82, an outlet 90, a pressure switch 86 and may rest upon a scale 84. Outlet 90 connects to an exhaust line 92 having an exhaust valve 88 that is connected to pressure switch 86. In another embodiment, purge vessel 80 does not include exhaust valve 88 and exhaust line 92, for example, when purge vessel 80 is to be disconnected, removed, and treated offsite.

Solenoid valve 94 is connected to vaporizer 100 via inlet 96. Vaporizer 100 includes an outlet 102 connected to delivery line 106 and pressure switch 104. The present invention should not be limited to the vaporizer described herein and persons of ordinary skill in the art will appreciate that the present invention includes vaporizers other than those specifically described herein. Furthermore, the present invention should not be limited to a vapor production portion 14 having a vaporizer as described herein, and persons of ordinary skill in the art will appreciate that the present invention includes vaporization devices other than those specifically described herein.

Delivery line 106 is the beginning of delivery portion 16 of system 10. Conduit 106 communicates fluid to a valve 108 having a backpressure regulator 109, valve 10, buffer tank 112, valve 114, valve 116 having pressure regulator 117 and pressure transducer 118, before conduit 120 carries the vaporized gas to the end user (not shown). The present invention should not be limited to the delivery portion described herein and persons of ordinary skill in the art will appreciate that the present invention includes delivery portions other than those specifically described herein.

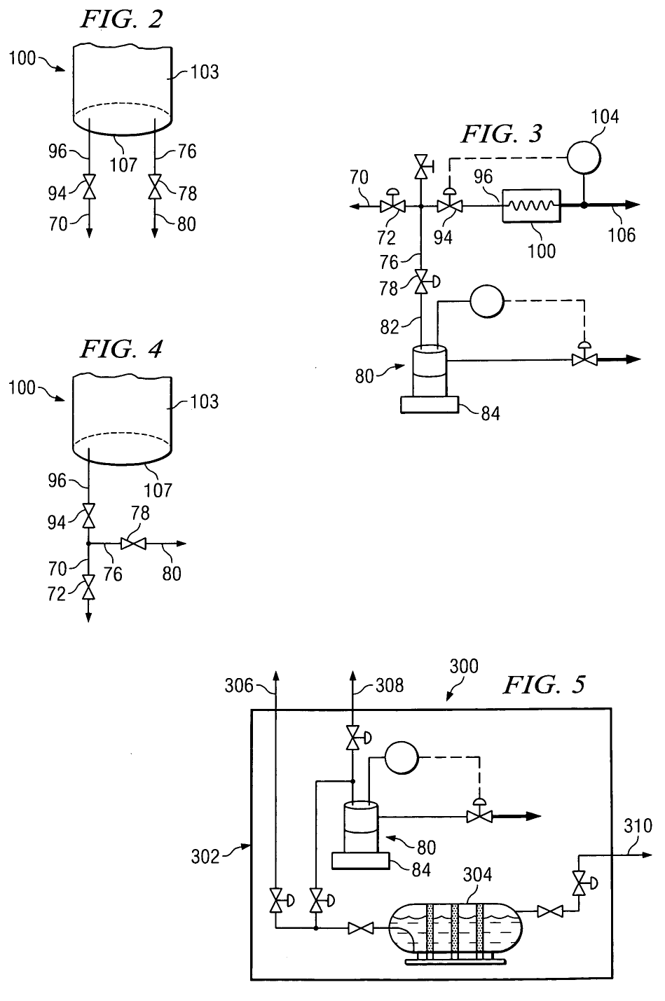

Referring to FIG. 2, an exemplary embodiment in accordance with the invention is shown. Vaporizer 100 is shown schematically as a cylinder 103 having bottom end 107. In one location, inlet 96 having valve 94 connects to end 107. Valve 94 allows fluid communication with supply line 70. In a second location, purge line 76 having valve 78 connects to end 107. Valve 78 then communicates with purge vessel 80. The arrangement of FIG. 2 allows greater control of over purging vaporizer 100 because purge vessel 80 may receive fluids from vaporizer 100 independent of supply line 70. Vaporizer 100 may be purged to vessel 80 only when necessary, and not simply every time solenoid valve 94 is in use.

Referring to FIGS. 3 and 4, another exemplary embodiment in accordance with the invention is shown FIG. 3 shows the portion of vapor portion 14 from supply line 70 to vapor delivery line 106, including some differences described below. Supply line 70 is connected to valve 72. Liquid supply from valve 72 is then directed to both valve 94 and purge line 76. In FIG. 4, vaporizer 100 is shown schematically as a cylinder 103 having bottom end 107. At one location of end 107, inlet 96 having valve 94 connects to end 107. Valve 94 allows fluid communication with supply line 70 and with purge line 76. Valve 78 controls fluid flow to purge vessel 80 and valve 72 controls fluid now to and from supply line 70. The arrangement of FIGS. 3 and 4 simplifies the fluid communication with vaporizer 100, and requires that solenoid valve 94 allow fluid flow back through valve 94 during purge to vessel 80.

The operation of system 10 will now be described, with reference to FIG. 1. Liquid phase ammonia is stored in container 20 while vaporizer 40 pressurizes the head space of container 20 and forces liquid phase ammonia into delivery line 70. The detailed operation of storage and pressure build circuit 12 is known to persons of ordinary skill in the art, and as previously mentioned, other devices and means for providing liquid phase ammonia are included without limitation.

Valve 72 may be opened to supply liquid ammonia to solenoid valve 94 and vaporizer 100 during normal vaporization and vapor phase delivery operations. At a given time, vapor flow out of vaporizer 100 may cease, for example, when the end user process does not require ammonia vapor flow, or when the impurity level in the liquid phase ammonia exceeds specification. Other reasons may exist for ceasing vapor flow from vaporizer 100. Valve 110 is closed downstream of vaporizer 100, thereby stopping vapor flow from vaporizer 100. Furthermore, valve 72 upstream of vaporizer 100 is closed. Even though no flow is allowed downstream of vaporizer 100, the heater within vaporizer 100 remains in operation, for example, at approximately 75° C. Thus, the ammonia pressure within vaporizer 100 increases (up to approximately 500 p.s.i., for example) until it reaches a predetermined pressure as sensed by pressure switch 104. Upon sensing the predetermined pressure, pressure switch 104 directs solenoid valve 94 to close the liquid flow from delivery line 70 to inlet 96 of vaporizer 100. However, solenoid valve 94 is adapted to allow fluid flow from inlet 96 back toward valve 94.

Substantially at the same time that solenoid valve 94 allows ammonia fluid flow back toward valve 94 from vaporizer 100, valve 78 is opened. The pressure in vaporizer 100 is greater, than the pressure in liquid purge vessel 80, so liquid ammonia from vaporizer 100 will flow though valve 78 and into purge vessel 80. After a predetermined mass change in purge vessel 80, as detected by scale 84, valve 78 is closed. Valve 88 may then be used to exhaust the contaminated liquid ammonia through exhaust line 92 to some form of abatement, for example, a scrubber. Alternatively, liquid purge vessel 80, when full, may be disconnected and replaced by another purge vessel. A full vessel may be detected by a scale. The contaminated purge vessel may then be sent offsite to be treated and recycled while the newly connected purge vessel is enabled to receive purged liquids. After the contaminated product is purged, vaporizer 100 may be re-supplied with flesh liquid ammonia by appropriately actuating solenoid valve 94 and opening valve 72. Vapor flow out of vaporizer 100 is continued by opening valve 110.

In another embodiment of the invention, supply line 70 to valve 94 to vaporizer inlet line 96 may be separate from purge line 76 to purge valve 78 to purge vessel 80, as previously described with reference to FIG. 2. Contaminated liquid ammonia may be purged from vaporizer 100 while separately supplying vaporizer 100 with pure ammonia. In a further embodiment of the invention, valve 94 allows contaminated ammonia to be purged back through valve 94, as shown in FIGS. 3 and 4. In yet another embodiment of the invention, solenoid valve 94 is removed from the system. In this system, valves 72 and 110 are directed to close while valve 78 is opened, which directs liquid ammonia into vessel 80. Still other embodiments of the invention include real-time purge of contaminated ammonia, wherein the supply of ammonia in line 70 and/or the delivery of vapor in line 106 continues uninterrupted while contaminated liquids in vaporizer 100 are purged. While contaminated ammonia is in the liquid delivery lines, purge and vapor flow out of the vaporizer may also be taking place.

Thus, as shown and described, purge vessel 80 provides an upstream purge of the contaminated liquid in vaporizer 100, and the purge may be executed only when necessary and oil an intermittent basis. Further, purge vessel 80 is adjacent the point of use and helps maintain the purity of the vaporized gases that are created and delivered in close proximity to the point of use. Such an arrangement further ensures that the fabrication system remains operational. In alternative embodiments, it will be understood that the liquid outlet for vaporizer 100 may be disposed in other locations on vaporizer 100, such as adjacent outlet 102 or the underside of vaporizer 100. It will also be understood that purge vessel 80 may be connected to containers other than vaporizer 100. For example, and with reference to FIG. 5, apparatus 300 includes a purge vessel 80 connected to ton vessel 304. Ton vessel 304, with a storage capacity of approximately 900 liters, stores a significant volume of liquid ammonia. Unlike vaporizer 100 and vapor portion 14, apparatus 300 with ton vessel 304 is located outside of fib 18, such as at backpad 302 that may be approximately 100 yards from the fab. Ton vessel 304 is used for onsite storage of liquid ammonia that is apart from but readily accessible relative to the fab. Line 306 may connect to another source container. Line 308 may connect to another ton vessel, or may provide a purge point during disconnection of purge vessel 80. Line 310 connects to the vaporizer in the fab. Furthermore, persons of ordinary skill in the art will appreciate that the present invention may be used to purge other vessels than those specifically described herein. Additionally, the vessel to be purged may contain varying liquids known to persons of ordinary skill in the art, including liquids that are not contaminated as defined herein, and such liquids may be purged in accordance with the embodiments of the invention described herein.

The liquid purge of ammonia from vaporizer 100 as previously described may be connected to a triggering event, such as a detection of the accumulation of impurities in the liquid ammonia in vaporizer 100. When a predetermined level of impurities is reached and purge is needed, a command may be given to purge the contaminated liquids. The triggering event may also be a predetermined time period for operation of vaporizer 100. Further, a detected weight change in the source container may be used to indicate excessive contamination levels. The details of impurity detection are known to persons having ordinary skill in the art, and, thus, are not provided herein.

Vaporized ammonia that exits outlet 102 enters conduit 106 of delivery portion 16 of the system. Conduit 106 delivers the vapor phase ammonia to valve 108 and backpressure regulator 109. Backpressure regulator 109 is used to control upstream pressure of the liquid ammonia to avoid vaporization of ammonia in the liquid delivery lines. Downstream of the backpressure regulator 109 is a buffer tank 112 to provide a buffer capacity for the vaporized ammonia before delivery to the point of use, as is known to persons of ordinary skill in the art. However, buffer tank 126 is optional. Operation of the other components of delivery portion 16 serves to efficiently provide vaporized ammonia, or any other chemical gas, to the point of use and is known to persons of ordinary skill in the art.

System 10 includes certain parts, such as pressure sensors, pressure switches, temperature sensors, and valves, that are important to the system but which were not specifically described because their use and operation are well known to persons of ordinary skill in the art. Furthermore, the valves shown and described herein may be check valves, solenoid valves, three-way valves or any other various valves known to persons of ordinary skill in the art. The present invention should not be limited to the valves described herein and persons of ordinary skill in the art will appreciate that the present invention includes valves other than those specifically described herein. Furthermore, the overall control system is not shown or specifically described herein, as any suitable control system known to persons of ordinary skill in the art may be used in conjunction with the embodiments described herein. For example, a central control system, such as a programmable logic controller (PLC), may be used to operate the various devices in system 10.

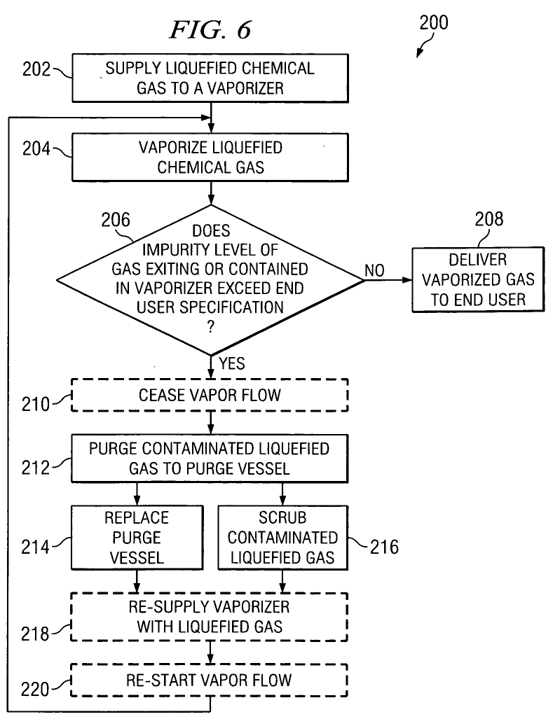

With reference to FIG. 6, a flow diagram is shown representing a process 200 to which the various embodiments described herein are directed. First, liquefied chemical gas is supplied to a vaporizer shown as box 202. At 204, the liquefied gas is vaporized. At 206, a determination is made—does the impurity level of the gas exiting or contained in the vaporizer exceed the end user specification? If “no,” then the vaporized chemical gas is delivered to the end user at 208. If “yes,” box 210 shows that it is optional to cease the vapor flow, if so desired. If real-time purge is chosen, wherein vapor flow out of the vaporizer is continuous, the box 210 may be bypassed. At 212, the contaminated liquid product in the vaporizer is purged to the purge vessel. At this point, purge vessel may be replaced at 214 or the contaminated liquid in the purge vessel may be exhausted and scrubbed at 216. If replaced at box 214, the purge vessel is sent offsite to be treated and may be recycled to be used again. At 218, it is optional to re-supply the vaporization vessel with pure liquefied gas. The vapor flow may then be re-started at 220, which is also an optional step depending on whether vapor flow was stopped at box 210. After box 220, the liquefied chemical gas may again be vaporized at 204.

The above discussion is meant to be illustrative of the principles and various embodiments of the present invention. While the preferred embodiment of the invention and its method of use have been shown and described, modifications thereof can be made by one skilled in the art without departing from the spirit and teachings of the invention. The embodiments described herein are exemplary only, and are not limiting. Many variations and modifications of the invention and apparatus and methods disclosed herein are possible and are within the scope of the invention. Accordingly, the scope of protection is not limited by the description set out above, but is only limited by the claims which follow, that scope including all equivalents of the subject matter of the claims.

What is claimed is:

1. An apparatus for supplying a liquefied chemical gas comprising:
a vaporizer disposed within a fabrication plant, the vaporizer adapted to receive the liquefied chemical gas and output a vaporized chemical gas;
a purge vessel connected to and in fluid communication with the vaporizer; and
wherein the vaporizer is adapted to purge a volume of the liquefied chemical gas and the purge vessel is adapted to receive the volume of liquefied chemical gas.

2. The apparatus of claim 1 wherein the volume of liquefied chemical gas is contaminated.

3. The apparatus of claim 1 wherein the purge vessel is connected to a supply inlet of the vaporizer.

4. The apparatus of claim 3 further comprising a first valve disposed between the purge vessel and the vaporizer supply inlet.

5. The apparatus of claim 4 further comprising a solenoid valve disposed between the first valve and the vaporize supply inlet.

6. The apparatus of claim 1 wherein the vaporizer further comprises a connection to a liquefied chemical gas source container separate from the purge vessel connection.

7. The apparatus of claim 1 further comprising:
a vaporizer inlet and an inlet valve disposed upstream of the inlet; and
a vaporizer outlet and an outlet valve disposed downstream of the outlet.

8. The apparatus of claim 7 further comprising a pressure switch disposed between the outlet and the outlet valve, the pressure switch coupled to the inlet valve.

9. The apparatus of claim 1 wherein the purge vessel is adapted to be replaced by a second purge vessel, and the purge vessel is recyclable.

10. The apparatus of claim 2 wherein the purge vessel further comprises an exhaust line adapted to exhaust the contaminated liquefied chemical gas.

11. An apparatus for purging a liquefied chemical gas from a vaporizer comprising:
a vaporizer having a contaminated liquefied chemical gas and a vaporized chemical gas;
a purge vessel in fluid communication with the contaminated liquefied chemical gas; and
means for purging the contaminated liquefied chemical gas from the vaporizer to the purge vessel.

12. The apparatus of claim 11 further comprising means for allowing flow of a substantially pure liquefied chemical gas in a first direction relative to the vaporizer and flow of the contaminated liquefied chemical gas in a second direction relative to the vaporizer.

13. The apparatus of claim 12 wherein the flow means includes a solenoid valve.

14. The apparatus of claim 11 further comprising means for detecting contamination of the liquefied chemical gas.

15. The apparatus of claim 11 further comprising means for pressurizing the vaporizer above a normal flow condition.

16. An apparatus for purging a liquefied chemical gas comprising:
a ton vessel disposed apart from a fabrication plant, the ton vessel including a liquefied chemical gas and a heater, the ton vessel in fluid communication with a vaporizer disposed within the fabrication plant;
a purge vessel connected to and in fluid communication with the ton vessel; and
wherein the ton vessel is adapted to purge a volume of the liquefied chemical gas and the purge vessel is adapted to receive the volume of liquefied chemical gas.

17. A method of purging a liquefied chemical gas comprising:
supplying a liquefied chemical gas to a vaporizer disposed within a fabrication plant;
vaporizing the liquefied chemical gas in the vaporizer;
operating the vaporizer for a period of time; and
purging any contaminated liquefied chemical gas from the vaporizer to a purge vessel.

18. The method of claim 17 further comprising:
stopping a flow of vaporized chemical gas from the vaporizer;
pressurizing the contaminated liquefied chemical gas in the vaporizer; and
forcing the contaminated liquefied chemical gas from the vaporizer to the purge vessel.

19. The method of claim 17 further comprising:
replacing the purge vessel with a second purge vessel.

20. The method of claim 17 further comprising:
exhausting the contaminated liquefied chemical gas to an external source.

21. The method of claim 17 further comprising:
detecting contamination of the liquefied chemical gas.

22. The method of claim 17 wherein the purging occurs without stopping a flow of vaporized chemical gas from the vaporizer.
